(19) United States
(12) Patent Application Publication
(10) Pub. No.: US 2025/0104034 A1
(43) Pub. Date: Mar. 27, 2025

(54) DISPLAY DEVICE GATED ON NON-FUNGIBLE TOKEN CONTRACTS

(71) Applicant: Facet Labs Inc., Boston, MA (US)

(72) Inventors: William J. Firestone, Boston, MA (US); Matthew P. Marcello, Brooklyn, NY (US)

(21) Appl. No.: 18/899,674

(22) Filed: Sep. 27, 2024

Related U.S. Application Data
(60) Provisional application No. 63/644,273, filed on May 8, 2024.
(60) Provisional application No. 63/540,848, filed on Sep. 27, 2023.

(51) Int. Cl. G06Q 20/12; G06Q 30/0601

(52) U.S. Cl. CPC G06Q 20/123; G06Q 30/0643; G06Q 2220/18

(57) ABSTRACT

The invention comprises a portable consumer display device that is paired with an on-sale physical product. The device is either packaged together with the physical product or marketed alongside it and will display digital experiences that are pushed to the device by the originating brand or producer for that product through a remote content management platform. Such a device may be herein referred to as a “facet.” Digital experiences sent to the facet might include images, videos, advertisements, text, documents, QR codes, interactive experiences, music, or digital art minted to smart contracts. Associated methods are also disclosed.

### CROSS-REFERENCES TO RELATED APPLICATIONS

This application claims priority to U.S. provisional patent application Ser. No. 63/540,848, filed on Sep. 27, 2023, and U.S. provisional patent application Ser. No. 63/644,273, filed on May 8, 2024, the contents of which are both incorporated herein by reference in their entirety.

### TECHNICAL FIELD

The present application relates generally to consumer display devices configured to display digital images, such as those in the form of non-fungible tokens (NFTs), or digital art. More particularly, the present application relates to electronic facets configured to display digital assets that are minted to confer consumer's rights in that digital content using an electronic contract, such as a smart contract, that the consumer enters into with the originating brand

### BACKGROUND OF THE INVENTION

Non-fungible tokens (NFTs) contain references to linked files such as artwork, photos, and videos (“digital art”). Recently several companies have designed digital display products for NFT-linked digital art which require the user to prove that they own an NFT in order to transfer the file to a display, such as the display on a digital watch or the display on a jewelry piece such as a pendant. Such a transfer is achieved by a software platform that gates file transfer based on ownership of a blockchain wallet, which is a digital file in which one can securely store and manage NFTs. Pillz and Tokenframe are two companies that utilize this process. As long as an NFT is owned by a supported wallet, the file can be transferred to an NFT display device associated with that wallet. Problematically, these NFT display products are agnostic with respect to the NFT creator, in that once the NFT has been sold to a customer, the customer can display it in any device of his choosing independently of the creators wishes. There has been no way for NFT creators to build physical products that can only receive and display art that they have created. Solving this problem is a benefit to creators, their fans and clients, and will enhance the potential for customized digital display devices which are designed to pair with specific NFTs or digital assets.

Relatedly, consumer brands include a range of marketing products inside of product packaging (e.g., a shoe company including a commemorative booklet celebrating an athletic achievement) as part of their after-sale client engagement efforts. Stylized boxes, informational pamphlets, and branded giveaways like stickers or keychains are all traditional post-sale marketing products with which we are all familiar. Recently many consumer brands have introduced packaging products that aim to bring consumers (also referenced herein as users) into their digital ecosystem. One popular strategy is the inclusion of cardstock featuring QR codes that are linked to social media channels or to websites that showcase product information or general branding from the product creator. Problematically, post-sale consumer engagement with these products is short lived. Traditional packaging is thrown away, and consumers are inundated with so many targeted advertisements online that they quickly lose contact with brands after a purchase. To continue targeting their former clients, brands are left to fight an expensive battle for clicks and attention across browsers and social media. There has been no way for producers—marketing professionals responsible for creating new business through various advertising and public relations efforts—to ensure that their digital advertising cuts through the noise and reaches a digital display device belonging to their former clients. Solving this problem is also a benefit to producers, their partners, fans, and clients. The present invention will enhance the potential for efficient delivery of branded digital experiences to consumers. Furthermore, this invention will enhance the potential for customized digital display devices that are designed to pair with specific products and brands.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments of the present application include a consumer device which will only display digital art that is owned by the user and that is minted through an electronic contract, such as a smart contract, that the art's creator has added to a whitelist. The device may comprise an enclosure, micro-controller, custom firmware, one or more digital display screens, one or more wireless data transmission components, and data storage. The device may communicate with a software platform that includes a smartphone app that can transfer digital art to the device, a wallet ownership verification service, a blockchain API service, and a contract whitelist. The device may be regulated by a “static” and/or a “dynamic” contract whitelist. In the “static” form, the device is encoded with a contract whitelist which is immutably stored in the device memory. In the “dynamic” form, a “creator-specific identifier” is immutably stored in the device's memory and in turn is used by the app to look up the current contract whitelist for the device. When an attempt is made to transfer an item of digital art from the app to the device, the software platform ensures that the digital art was minted through a contract on the whitelist before allowing the transfer.

Other embodiments of the present invention include a portable consumer display device that is paired with an on-sale physical product but can be held and manipulated separate and apart from the physical product. The device may either be packaged together with the physical product or marketed alongside it and may display digital experiences that are pushed to the device by the originating brand or producer for that product through a remote content management platform. Such a device is herein referred to as a “facet.” Digital experiences sent to the facet might include images, videos, advertisements, text, documents, QR codes, interactive experiences, music, or digital art minted to an electronic contract such as a smart contract.

The facet may comprise an enclosure, micro-controller, custom firmware, digital display screen, wireless data transmission component, data storage, and a power source (e.g., a battery). The facet communicates with a content management system platform over the Internet. The producer uses that platform to control the deployment of digital experiences to the facet.

To illustrate the utility of this invention, imagine a small facet that is included with a pair of exclusive sneakers being sold by a major sportswear manufacturer (e.g., Adidas). Imagine that Adidas is teaming with a creative celebrity (e.g., Kanye West) to promote or design the sneakers. When the facet is charged and turned on, the facet boots up and runs a single purpose player application. Adidas is then able to remotely allow for the transfer of digital content experiences to the facet that come from, or are otherwise associated with, Kanye West. These digital experiences provide entertainment and information to consumers of the sneakers and strengthen their connection to the issuing brand, which in this example is Adidas, and the creative celebrity associated with the sneakers, which in this example is Kanye West.

Optionally, the facet will display a copy of digital content, such as art, that is owned by the consumer and/or made available to the consumer, by minting the consumer's rights in that digital content using a contract, such as a n electronic contract, that the consumer enters into with the originating brand (i.e., of the product with which the facet is being sold) or art's creator. Digital art can originate from creative authors who are associated with the producer responsible for marketing the product with which the facet is sold. The art can be any form of media including artwork, music, images, videos, text, and animation.

Returning to the foregoing Adidas example, at some time after the sale of a pair of Adidas sneakers designed by Kanye West, Kanye West may produce art that is minted using an electronic contract, such as a smart contract, and marketed to consumers of the sneakers he designed. In this case Adidas could push the art to a facet belonging to consumers that are registered parties to that contract.

The invention may also comprise a consumer device, also referenced as a “facet,” which may only display digital art that is owned by the user, that is minted through a smart contract that the device's creator has added to a whitelist, and that is pushed by the user to the device using the application.

The facet comprises an enclosure, micro-controller, custom firmware, digital display screen, speaker, a wireless data transmission component, battery, and data storage. The facet communicates with a software platform that includes a software application (such as a smartphone application, called “the App”) that can transfer digital art to the facet, a wallet ownership verification service, a blockchain API service, and a contract whitelist.

Embodiments of the present invention may also comprise a system that gates the facet by linking a “smart contract whitelist” to the facet's memory. A variation of that system is described herein and comprises an architecture that gates the facet by linking a “smart contract whitelist” to a mobile smartphone/smart-tablet “App” (as defined above) used to transfer digital art to the device. Art transferred to the facet must be linked to whitelisted contracts using the App under this variation of the system.

In the “static” form of the contract whitelist, the App is encoded with a contract whitelist which is stored in the App memory. In the “dynamic” form, a “creator specific identifier” is stored in the App and in turn is used by the App to look up, perhaps over the Internet, the current contract whitelist. In order for an item of digital art to be transferred to the device, the software platform will ensure that the NFT was minted through a contract on the whitelist.

The hardware, look, feel, and design of the device may have customized or branded designs or styling, and functionally be used as a product tag, a toy, a key chain, a necklace or other jewelry, a picture frame, a wall poster, a sculpture, or otherwise. When sold as marketing collateral with an underlying product such as a sneaker, the device can be used separate and apart from the product being marketed (e.g., the sneaker).

To illustrate the utility of this invention, consider that the Boston Celtics (a “creator”) have sold digital memorabilia items, minted through smart-contracts, to fans. The invention allows the Boston Celtics to offer a digital device—a facet—so that digital memorabilia owners can enjoy a customized, purpose-built facet for displaying only those memorabilia items. The facet might have a customized design, for example its physical shape, color, materials, detailing, or branding may be executed in a manner which is relevant to the Boston Celtics and their fans. Furthermore, if a user is able to display an item of digital memorabilia on a Celtics facet, this would indicate that the user owned, or was given permission to use the digital memorabilia, pursuant to an electronic such as a smart-contract. The Boston Celtics, or some other interested party, might use that knowledge as a feature for organizing other business channels involving their fans, for example as a form of ticketing.

The facet hardware system may comprise a configuration of switches, dials, toggles, buttons, wireless receivers, batteries, speakers, the display, the touch-screen, device sensors, and other parts. The facet has a customized hardware configuration where hardware components may be added or subtracted and programed into the device firmware. The facet's hardware system is able to communicate with the App. One purpose of the hardware system is to allow the user to interact with files transmitted to the facet, for example by starting, pausing, changing, deleting, scrolling, zooming, or transmitting.

The creator may design a custom functionality into aspects of the hardware system. These designs may depend on the nature of the electronic contract for which the facet has been specifically designed. For example, a button could produce a particular action inside of the App running on the facet, such as the listing of a electronic contract for sale on an exchange. Alternatively, a button or toggle could produce an experience on the facet, such as modifying the viewing angle, resolution, or position of the file that renders the media on the digital display. Art connected to a smart contract may in some cases be designed in such a way that it is most effectively viewed and enjoyed on a facet that utilizes a particular hardware configuration conceived by the art creator.

### BRIEF DESCRIPTION OF DRAWINGS

The drawings accompanying and forming part of this specification are included to depict certain aspects of the present invention. A clearer impression of the invention, and of the components and operation of systems provided with the present invention, will become more readily apparent by referring to the exemplary, and therefore non-limiting, embodiments illustrated in the drawings, wherein identical reference numerals designate the same components. Note that the features illustrated in the drawings are not necessarily to scale.

FIG. 1 depicts a schematic diagram of components of a preferred embodiment of the present invention.

FIG. 2 depicts a perspective view of a portable facet device according to an exemplary embodiment of the present invention.

FIG. 3 depicts a perspective view of internal components of the facet device of FIG. 2 according to an exemplary embodiment of the present invention.

FIG. 4 depicts an exploded view of the internal components of the facet device of FIG. 3 according to a preferred embodiment of the present invention.

### DETAILED DESCRIPTION OF THE INVENTION

### A. Digital Electronic Consumer Device (i.e., a “Facet”)

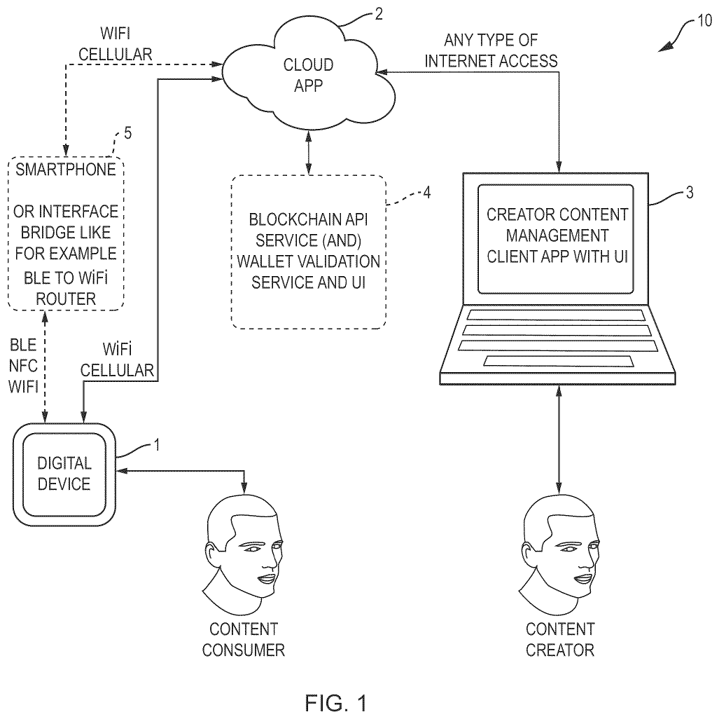

Referring to FIG. 1, in a system of the present invention 10 a digital electronic consumer device (a facet) 1 serves as a “client engagement” device and is used to show digital content and experiences that are pushed by the producer serving as or working with a content creator. The hardware of the facet and the look and feel of the facet may have customized or branded designs or styling, serving the function of a product tag, a key chain, a necklace or wearable, a toy, a picture frame, a wall poster, a sculpture, or otherwise, and will be either packaged along with the sale of physical consumer products or marketed by consumer product brands. The facet may also have the following features:
1) Battery powered with charging ability over USB, magnetic connector, wireless charging or energy harvesting. A lithium polymer (LiPo) battery works well for example, due to its high energy density and availability in different sizes.
2) Energy harvesting approach for rare usage scenarios could be utilized to make the facet fully energy-autonomous. Energy sources could comprise a photovoltaic (PV) solar panel installed under the display or otherwise be a part of the facet's enclosure. Peltier modules or electromagnetic harvesting could be used for wearable versions of the facet, where there is often contact with skin or vibrations generated by the consumer as she is engaged in physical activities like walking or running.
3) Application display with such criteria as high contrast, high pixel density, sunlight readable and energy efficiency are required (OLED or AMOLED based displays for example), and a speaker.
4) Wireless connectivity BLE/WiFi/Cellular/NFC and the like, or combinations of the foregoing, for updating content on the facet directly from the cloud Web APP Backend or using user smartphone or other multi interface device as a bridge between the Web APP and the facet.
5) Microprocessor or Linux/Android powered microcomputer with sufficient amount of storage memory to store content/APPs.
6) Computing power required to play smooth animations/videos or music, show images with support of decoding different formats like JPEG, PNG, MP3, MP4, GIF to achieve smooth content appearance, minimum power consumption and optimal image quality.
7) CPU speed, RAM speed and size to be matched with appropriate content format to achieve smooth animation rendering on 20+ FPS or preferably 30 FPS.
8) Quick content transferring, considering low speed interfaces such as BLE/NFC, is achievable by optimizing content for the display resolution and color map, and by utilizing compression and decompression techniques. For example: a GIF file could be transferred over the BLE from smartphone or commercial BLE to Wi-Fi/Cellular gateway; after it's transferred, it's decoded to occupy an array of optimized bitmap frames and when the facet is used, direct memory access (DMA) operation allows the facet to display smooth animation on a high resolution display on a facet that is centered around a low power microcontroller unit (MCU) without producing significant heat, and that consumes energy efficiently.
9) Device Unique Identifier that is a read-only parameter, implemented for example as an array of bytes, which are embedded into the facet's hardware or software.
10) Optionally, the facet will display digital content, such as art, that is owned by the user and/or made available to the user by minting the user's rights in that digital art using an electronic contract such as a smart contract that the user enters into with the art's creator or product's brand owner for example.
11) The facet might have a customized hardware configuration where hardware components are added or subtracted and programed into the device firmware. For example, switches, dials, buttons, the display, the touch-screen, device sensors, and other parts, may be given a custom functionality designed by the creator.
12) The facet might display interactive experiences which are navigated by the user using the touch-screen or through button presses or some other hardware signal generated by the user. Interactive experiences are comparable to a smart-phone application or a website, which may be deployed by the creator to capture customer insights and analytics, execute product sales, or provide information and entertainment. Examples of interactive experiences include a user survey, a searchable catalogue with products for sale, or a video game.

### B. Cloud App

Referring back to FIG. 1, the Cloud App 2 is used as a cloud storage buffer for digital content. The Cloud App 2 technical implementation comprises two core logical parts, the “front end” and “back end.”
1) The front end is for content creators to manage content on one or more distributed facets and see data insights pertaining to user interaction with content displayed on the facet. The front end communicates with a Web Application (see below for “Content Creator Client App”) that is available to the content creator on different platforms, for example as a Web Application in browsers or as a dedicated App in various popular platforms such as iOS, Android, Windows, Mac, Linux.
2) The back end implements features of the business logic of the Web Application such as data processing from the content creator that comes in through the front end. The Web App itself is interacting with a cloud storage folder or database that is vital for the management of user accounts and platform executions.
3) The back end's API exposes endpoints to the facet. A facet with integrated Wi-Fi or cellular connectivity and a Device Unique Identifier (DUI) can check if there is new content available. If content is available the facet downloads that content and processes it in order to make it accessible to the content consumer.
4) Using the same interface, the facet can update internal software to fix bugs or add new features. The facet can also broadcast information about itself to the Cloud App, such as the device's location, firmware, digital content history or proof-of-play. The facet can also broadcast user information, analytics, or commands taken from the device.
5) A Device Unique Identifier is a read only parameter, typically implemented as an array of bytes, which are embedded into the facet's hardware or software. For example MCU microcontrollers have available unique 12 Bytes length ID for each manufactured chip from STM32LA family. Device IDs in this case serve as Device Unique Identifiers and are filed with the Cloud App database for further facet identification. Each time the facet communicates with the Cloud App, it will share its device unique identifier, and the Cloud App knows “who” is asking to reply with accessible content if such access to such content was made available by Content Creator for example.
6) The Content Creator links Device Unique Identifiers to specific Content Consumer Groups. That gives the Content Creator the ability to push content only to target audience.
7) The Backend API could be used by a licensed third party to create a custom user interface (UI) interface on any platform which can interact with the API. For example licensed company “X,” by obtaining access to the API, can design their own unique looking interface for platform “N” to achieve a completely unique visual appearance using developed content management, content delivery, metrics collection and other tools exposed as backend API.
9) Optionally, the Cloud App will be able to send/push digital content, such as art, that is owned by the user and/or made available to the user by minting the user's rights in that digital art using an electronic contract such as a smart contract that the user enters into with the art's creator or associated product's producer for example.

### C. Content Creator Client App

Referring back to FIG. 1, the Content Creator Client App 3 is a Web Application that works from any browser and could be implemented using a programming language such as JS (JavaScript) and popular frameworks like React, Vue.js, Angular. The Web App user interface should not require a knowledge of technology or specific education but it should be intuitive so the brand owners can easily publish content to the facets.

Web App core features include 1) registration for content creator, 2) registration for a new facet using Device Unique Identifier (DUI), 3) assignment of DUI to the consumer group, 4) pushing content to the facet, 5) features for content processing to create and optimize digital experiences for different facet hardware models and integrate to the Cloud App 6) scheduling deployment of experiences to facets, 7) analytics of other statistics collected from facets, including measurement of interactive experiences 8) scheduling specific content to show up on facets by external events such as certain mechanical movements of the facet or the facet reaching a certain location, and 9) optionally, pushing smart-contract linked art to the facet.

### D. Blockchain API Service (Optional)

Still referring to FIG. 1, the facet device 1 and its Device Unique Identifier (DUI) (not numbered) are linked to a public key or “crypto wallet” controlled by the device owner. The Blockchain API service 4 generates a list of electronic contracts associated with the DUI and if instructed the Cloud App pushes selected contract-linked art to the facet.

Device Unique Identifier is a read only parameter, in other words an array of bytes, which are embedded into the facet's hardware or software. When the facet communicates with Cloud App, the facet will share its DUI with the Cloud App. The system facilitates the linking of a DUI to an electronic contract or crypto wallet account, either through a Wallet Ownership Validation Service (see below for detail), which would rely on a cryptographic validation, or a ledger stored in the system.

The Cloud App 2 receives a command to push art linked to an electronic-contract to a digital device (facet) 1.

Each time the facet 1 communicates with the Cloud App 2 it will share the unique identifier and the Cloud App 2 will query the Blockchain API Service for a list of smart contracts connected to the DUI.

The Cloud App 2 searches the list for electronic contracts that were pushed to the facet.

The Cloud App 2 mediates download and delivery of linked content to the facet.

### E. Wallet Ownership Validation Service

The Cloud App 2 utilizes a Wallet Ownership Validation Service and provides a user interface to facet owners. The purpose is to link the DUI to a crypto wallet controlled by the facet user. A user may request a cryptographic challenge from a Wallet Ownership Validation Service. The Wallet Ownership Validation Service generates a cryptographic challenge (nonce) to be signed with the user's private key. The user signs the nonce with their private key and submit the signed message to the Wallet Ownership Verification Service. The Wallet Ownership Verification Service cryptographically validates the signature, confirming the user's ownership of the crypto wallet (public/private key pair). An encrypted token is then generated by the Wallet Ownership Verification Service.

The Cloud App 2 scans the token and forwards it to the Wallet Ownership Verification Service to be redeemed. The encrypted token is cryptographically validated and redeemed, and the user's wallet is registered within the Cloud App 2 and connected to the user's Device Unique Identifier.

### F. Bridge/Smartphone

Still referring to FIG. 1, the device (facet) 1 could be used in tandem with a proximately positioned smartphone 5 application (APP) running on an iOS or Android platform. The smartphone 5 can run a Content Consumer specific APP, and/or download content from the Web APP over Wi-Fi or Cellular. Content can be optimized to be suitably rendered on a specific facet and transferred from the smartphone to that Facet using any of a number of possible protocols such as Bluetooth Low Energy (“BLE”). Advantages of this approach include significantly less hardware cost for the facet than a facet with similar functionality that directly communicates with other devices using cellular or WiFi protocols. Also BLE has very low power consumption to keep battery charge for longer usage periods without charging.

The present invention discloses a system comprising several key components, namely the Facet Device 1, an Application (termed “the App”) which may be a Mobile Application on a smartphone 5, Wallet Ownership Verification Service, a Contract Whitelist Service, Contract Whitelist, and a third-party Blockchain API Service 4. The system facilitates the management and display of non-fungible tokens (NFTs) according to ownership of NFTs and a whitelist of approved NFT smart contracts.

### G. Associated Methods

In a first step, creators may establish a static and/or a dynamic Contract Whitelist. A static Contract Whitelist may comprise an indelible electronic list of approved electronic contracts that may be stored on a facet. A dynamic Contract Whitelist may comprise a Creator Specific Identifier that may be stored on a facet and be associated with a separate Contract Whitelist of approved smart contracts. Creators maintain the Contract Whitelist by registering approved smart contracts with a Contract Whitelist Service.

In a next step, the facet advertises itself to nearby wireless transmission clients, and the App establishes a secure connection to the facet and stores the facet's Device Unique Identifier (DUI). A shared secret is then exchanged between the App and the facet/device during the initial pairing process, which serves as an authentication mechanism for all future interactions.

In a next step, a user requests a cryptographic challenge from a Wallet Ownership Validation Service. This Service generates a cryptographic challenge (nonce) to be signed with the user's private key. Users sign the nonce with their private key and submit the signed message to the Wallet Ownership Verification Service. The Wallet Ownership Verification Service then cryptographically validates the signature, confirming the user's ownership of the crypto wallet (public/private key pair).

In a next step, an encrypted token is generated by the Wallet Ownership Verification Service. The Application then scans the token and forwards it to the Wallet Ownership Verification Service to be redeemed. The encrypted token is cryptographically validated and redeemed and the user's wallet is registered within the Application. The user may then view allowed NFTs in the Application.

In a next step, the App reads the static Contract Whitelist from its memory. Alternatively, the App may read a Creator Specific Identifier from its memory, said Creator Specific Identifier being associated with a separate list of approved contracts (e.g., a Whitelist). The App next submits the Creator Specified Identifier to the Smart Contract Whitelist Service to obtain a list of whitelisted smart contracts. The Application next submits a request to the third-party Blockchain API Service to retrieve a list of NFTs owned by the user within the set of NFTs minted by the whitelisted contracts.

At this point, allowed NFTs are rendered within the Application's NFT gallery. The Application may then transmit the selected NFT to the Facet Device wirelessly. The NFT may then be displayed on the Facet/Device.

### H. The Facet Device

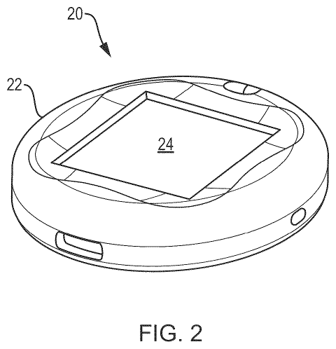

FIG. 2 is a perspective view of an exemplary facet device 20. It comprises a housing 22 and a screen 24.

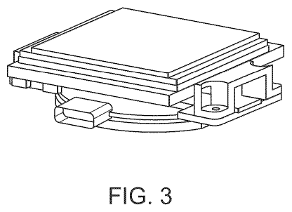

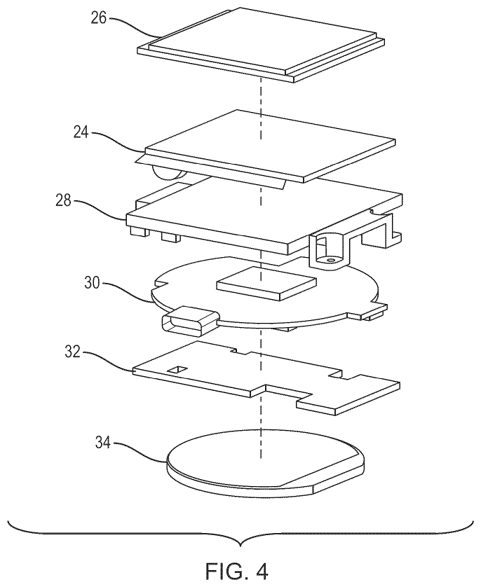

FIG. 3 is an exploded view of facet device 20. Referring to FIG. 3, the internal components comprise a screen protector 26, screen 24,28 access housing 28, a printed circuit board 30, a battery housing 32, and a battery 34. FIG. 4 is a perspective view of facet device 20.

1. A portable consumer device for displaying creator-authorized digital content comprising:
means for generating a contract whitelist in a digital memory comprising at least one smart-contract for authorizing the display of creator-authorized digital content on the device;
means for electronically downloading creator-authorized digital content to the device and rendering the content on the device if the smart-contract corresponds to the creator-authorized digital content.

2. A portable consumer device for displaying creator-authorized digital content comprising:
means for generating a contract whitelist in a digital memory external to the device comprising at least one smart-contract for authorizing the display of creator-authorized digital content on the device;
means for generating a creator-specific unique identifier in a second digital memory associated with the device;
means for associating the creator-specific unique identifier with the contract whitelist;
means for downloading the creator-authorized digital content to the device only if the smart-contract corresponds to the creator-authorized digital content.

3. The device of claim 2 wherein the device is a facet.

4. The device of claim 3 wherein the facet is provided with a product being marketed using the facet.

5. The device of claim 4 wherein the creator-authorized digital content is updated after the product is sold.

6. The device of claim 1 wherein the means for electronically downloading step comprises a means for downloading the creator-authorized digital content via a wireless medium.

7. The device of claim 2, wherein the creator-authorized digital content on the device is encrypted.

8. The device of claim 7, wherein the creator-authorized digital content is decrypted only if the creator-authorized digital content is associated with the smart-contract.

9. The device of claim 2, wherein the contract whitelist is stored on an associated computing device.

10. The device of claim 2, wherein the contract whitelist is stored on a cloud API.

11. A portable consumer device for displaying creator-authorized digital content comprising:
means for generating a contract whitelist in a digital memory external to the device comprising at least one creator-controlled electronic contract for authorizing the display of creator-authorized digital content on the device;
means for generating a creator-specific unique identifier in a second digital memory associated with the device;
means for associating the creator-specific unique identifier with the contract whitelist;
means for downloading the creator-authorized digital content to the device if the electronic contract corresponds to the creator-authorized digital content.

12. The portable consumer device of claim 11 wherein the electronic contract is a smart contract.

13. The portable consumer device of claim 11 comprising means for enabling a user to wear the device as jewelry.

14. The portable consumer device of claim 11 comprising means for enabling a user to display the device as wall art.
